(19) United States
(12) Patent Application Publication
(10) Pub. No.: US 2020/0182298 A1
(43) Pub. Date: Jun. 11, 2020

(54) SLIDING RAIL HAVING POLYFORMALDEHYDE (POM) GROOVES

(71) Applicant: Tymphany Acoustic Technology (Huizhou) Co., Ltd., Huizhou City (TW)

(72) Inventor: Wenjie LIN, Huizhou City (CN)

(21) Appl. No.: 16/668,413

(22) Filed: Oct. 30, 2019

(30) Foreign Application Priority Data
Dec. 7, 2018 (CN) 201822051055.1

(51) Int. Cl. F16C 29/00

(52) U.S. Cl. CPC F16C 29/005

(57) ABSTRACT

A sliding rail includes a base, a connecting piece, a plurality of elastic pieces and a slider. The connecting piece passes through the elastic pieces and the slider, and is fixedly mounted on the base. The base has a pair of sliding chutes, a plurality of block pieces and a pair of POM grooves embedded into the sliding chutes. The slider has a pair of sliding strips and a plurality of plates. The elastic pieces are located between the block pieces and the plates. The sliding strips of the slider are accommodated in the POM grooves and slide on the base along the POM grooves. After the slider slides for a certain distance relative to the base, the elastic pieces makes the slider to back to the original position.

### CROSS REFERENCE TO RELATED APPLICATIONS

This application claims priority to CN 201822051055.1, which was filed on Dec. 7, 2018, and which is herein incorporated by reference.

### TECHNICAL FIELD

The present invention relates to the technical field of guide rail devices, and in particular to a sliding rail having polyformaldehyde (POM) grooves.

### BACKGROUND

As a mechanical component in a linear reciprocating motion, a sliding rail is generally composed of a base and a slider sliding relative to the pedestal. Under the action of an elastic piece, the sliding rail further has an automatic reset function.

The existing sliding rail often has only one sliding direction due to its structural design, that is, it only slides in one direction. Furthermore, due to the relatively large size, a large noise is produced easily in a sliding process, and a hand feeling experience is poor.

Therefore, it is necessary to optimize the structure of the existing guide rail, so that the guide rail has the small size and may move to left and right smoothly.

### SUMMARY

In order to solve the above-mentioned problems of the prior art, the present invention provides a sliding rail having POM grooves. The sliding strips of the slider are accommodated in the sliding chutes of a base, and available to respectively slide to left end and right end of the base along the POM grooves; after the slider slides for a certain distance, the elastic pieces pushes the slider to back to the original position; and the sliding process is stable and smooth, and has a low noise.

To this end, the present invention provides the following technical solution:

A sliding rail, comprising a base, a connecting piece, a plurality of elastic pieces and a slider, wherein the connecting piece passes through the elastic pieces and the slider, and is fixedly mounted on the base; the base has a pair of sliding chutes, a plurality of block pieces and a pair of POM grooves; the POM grooves are embedded into the sliding chutes; the slider has a pair of sliding strips and a plurality of plates; and the elastic pieces are located between the block pieces and the plates; and the sliding strips of the slider is accommodated in the POM grooves of the sliding chutes, and slides on the base along the POM grooves; and after the slider slides for a certain distance relative to the base, the elastic pieces makes the slider to back to the original position.

As a further description for the technical solution of the present invention, the slider can slide to two ends of the base respectively along the POM grooves.

The sliding strips of the slider are disposed on outer edges of the slider, and are opposite to each other. After the sliding strips are accommodated in the POM grooves of the base, the slider can slide on the base along the POM grooves. It is to be noted that, the sliding is bidirectional, that is, the slider can respectively slide to two ends of the base. After the slider slides for a certain distance relative to the base, the elastic pieces located between the block pieces and the plates are compressed; and by releasing the slider, the elastic pieces push the slider to back to an original position.

The POM is an abbreviation of polyformaldehyde and is a polyformaldehyde thermoplastic crystalline polymer. By embedding the POM grooves into the sliding chutes, because of the intrinsic self-lubricating property of the POM grooves, the sliding experience of the sliding rail is smoother and the noise is lower when the POM grooves are slidingly connected to the sliding strips.

As a further description for the technical solution of the present invention, the block pieces are located on the two ends of the base and are provided with a mounting hole; the plates are extended and bended from a top of the slider downwards; and a through hole is respectively provided on the plates.

As a further description for the technical solution of the present invention, the connecting piece passes through the elastic pieces and the through holes of the plates, and is fixedly mounted on the mounting holes of the block pieces. The connecting piece is mounted on the base, penetrates through the slider, and is configured to position and guide the elastic pieces.

As a further description for the technical solution of the present invention, two plates are provided on the slider, and correspondingly, two elastic pieces are also provided. That is, one elastic piece is disposed between the block piece on a left end of the base and one plate of the slider, and one elastic piece is further provided between the block piece on a right end of the base and the other plate of the slider. With the connection between the two elastic pieces, the slider is available to slide to left and right relative to the base, and back to the original position automatically.

As a further description for the technical solution of the present invention, the connecting piece is a shaft which is cylindrical; the shaft passes through the elastic pieces and the through holes and is fixedly mounted on the mounting holes of the block pieces to position and guide the elastic pieces.

As a further description for the technical solution of the present invention, the elastic pieces are a spring. The springs provide a rebounding force to the slider, so that the slider is available to back to the original position smoothly.

In conclusion, according to the sliding rail provided by the present invention, the slider is slidably connected to the base via the sliding connection between the sliding strips and the POM grooves, that is, the slider is available to slide to left and right relative to the base; and after the slider slides for a certain distance, the slider is pushed to the original position by the flexibility of the elastic pieces.

According to the sliding rail, because the sliding rail is with a small size, smooth and stable sliding process, low noise and an adjustable sliding force and sliding stroke as required, the sliding rail of the present application effectively improves the user experience of the sliding operation on the sliding rail.

### BRIEF DESCRIPTION OF THE DRAWINGS

FIG. 1 is an exploded diagram of a sliding rail having POM grooves according to the utility model.

FIG. 2 is an assembly finished product diagram of a sliding rail having POM grooves according to the utility model.

### DETAILED DESCRIPTION OF THE EMBODIMENTS

In order to understand the present invention conveniently, the present invention will be described more thoroughly in conjunction with the accompanying drawings and specific embodiments. Preferred implementation manners of the utility model are given in the accompanying drawings. However, the present inventionmay be implemented in many different forms and is not limited to the implementation manners described herein. Reversely, the purpose of providing these implementation manners is to understand the contents of the present invention more thoroughly and comprehensively.

It is to be noted that when an element is referred to as being “fixed on” another element, it may be directly on the other element or an intervening element may also be present. When one element is considered as being “connected to” the other element, it may be directly connected to the other element or an intervening element may also be present.

For the ease of reading, the “upper”, “lower”, “left” and “right” indicated according to the accompanying drawings are merely for indicating a relative reference position of each element and are not intended to limit the present invention.

Unless otherwise defined, all technical and scientific terms used herein have the same meaning as commonly understood by a person skilled in the art to which the present invention belongs. Terms used herein in the specification of the present invention are merely for describing the specific implementation manners but are not intended to limit the present invention.

### Embodiment 1

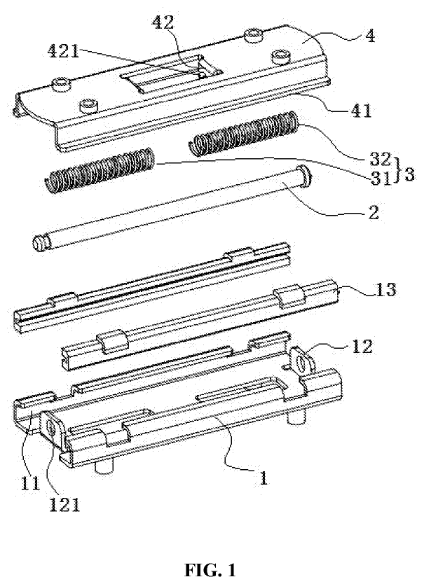

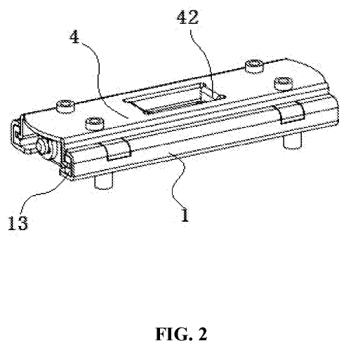

FIG. 1 and FIG. 2 respectively illustrate an exploded diagram and an assembly finished product diagram of a sliding rail in this embodiment. Referring to FIG. 1 and FIG. 2, a sliding rail having POM grooves includes a base 1, a connecting piece 2, elastic pieces 3 and a slider 4. The sliding rail of a rectangular structure uses the base 1 and the slider 4 as a main body structure. The connecting piece 2 and the elastic pieces 3 are accommodated in the main body structure. Correspondingly, the base 1 and the slider 4 are also of a rectangular structure. Two long edges of the base 1 are bent upwards to form U-shaped sliding chutes 11 of the guide rail.

It is to be noted that a groove body of each sliding chute 11 in this embodiment is relatively wide, and the POM grooves 13 also having a U-shaped structure are embedded into the sliding chutes 11. Two short edges of the base 1 are protruded upwards and are provided with a block piece 12 respectively. A mounting hole 121 is further provided on the block pieces 12. The mounting holes 121 on the two block pieces are located on a same straight line to mount the connecting piece 2. The connecting piece 2 is a shaft which is cylindrical, and is used to position and guide the elastic pieces 3.

For combining with the base 1, a cross section of the slider 4 has a convex structure which is corresponding to a cross section of the base 1. The slider 4 comprises two long outer edges, a sliding strip 41 which is arranged on each long outer edge, and the plates 42 which are extended and bent from a top of the slider 4 downwards. A through hole 421 is provided on the plates 42 respectively. A diameter of each through hole 421 is greater than a diameter of a cross section of the connecting piece 2, and is smaller than a diameter of a cross section of each elastic piece.

In this embodiment, the plates 42 are extended and bended from a middle of the top of the slider 4 downwards, and respectively include a left plate and a right plate (not labeled in the figure).

The elastic pieces 3 are located between the block pieces 12 of the base 1 and the plates 42 of the slider 4, corresponding to the left plate and the right plate of the slider. The elastic pieces include a first spring 31 on a left side and a second spring 32 on a right side.

About the connection between every components, first of all, the connecting piece 2 which is located inside passes through the first spring 31 and the plates 42 (a left plate and a right plate) of the slider 4 in sequence, and are fixedly mounted on the mounting holes 121 of the block pieces 12. Meanwhile, the sliding strips 41 of the slider 4 are accommodated in the POM grooves 13 of the sliding chutes 11 via the sliding strips 41, and slides on the base 1 along the POM grooves 13. It is to be noted that the slider 4 is available to respectively slide to left end and right end of the base 1 along the POM grooves 13.

The POM is an abbreviation of polyformaldehyde and is a polyformaldehyde thermoplastic crystalline polymer. By embedding the POM grooves 13 into the sliding chutes 11, because of the intrinsic self-lubricating property of the POM grooves, the sliding experience of sliding rail is smoother and the noise is lower when the POM grooves are slidingly connected to the sliding strips 41.

By pushing the slider 4 to slide to the right end of the base 1, when the slider 4 slides for a certain distance, which means the slider 4 is not at the original position, the second spring 32 is compressed; and after releasing the slider 4, the second spring 32 pushes the slider to slide to the left and automatically back to an original position. By pushing the slider 4 to slide to the left end of the base 1, when the slider 4 slides for a certain distance, which means the slider 4 is not at the original position, the first spring 31 is compressed; and after releasing the slider 4, the first spring 31 pushes the slider to slide to the right and automatically back to the original position.

In this embodiment, with the addition combination of the POM grooves in the sliding chutes, and because of the self-lubricating property of the POM grooves, the better smoothness is obtained and the noise is reduced.

In conclusion, according to the sliding rail, because the sliding rail is with a small size, smooth and stable sliding process, low noise and an adjustable sliding force and sliding stroke as required, the sliding rail of the present application effectively improves the user experience of the sliding operation on the sliding rail.

The above contents are merely examples and explanations for the structure of the present invention, and the description is specific and detailed but cannot be understood as a limit to the patent scope of the present invention thereto. It is to be noted that those of ordinary skill in the art may further make a plurality of variations and improvements without departing from the concept of the present invention and these obvious replacement forms all pertain to the protection scope of the present invention.

What is claimed is:

1. A sliding rail, comprising:
a base, comprising:
a plurality of sliding chutes;
a plurality of block pieces; and
a pair of polyformaldehyde (POM) embedded into the sliding chutes;
a slider comprising:
a pair of sliding strips accommodated in the pair of POM grooves and configured to slide on the base along the pair of POM grooves; and
a plurality of plates;
a plurality of elastic pieces located between the plurality of block pieces and the plurality of plates; and
a connecting piece passing through the plurality of elastic pieces and the slider,
wherein, after the slider slides for a certain distance relative to the base, the plurality of elastic pieces makes the slider return back to an original position.

2. The sliding rail having the POM grooves according to claim 1, wherein the slider is configured to slide to two ends of the base respectively along the pair of POM grooves.

3. The sliding rail having the POM grooves according to claim 2, wherein the plurality of block pieces is located at the two ends of the base and each of the plurality of block pieces is provided with a mounting hole,
wherein the plurality of plates is extended and bent from a top of the slider downwards, and
wherein a through hole is provided on each of the plurality of plates.

4. The sliding rail having the POM grooves according to claim 3, wherein the connecting piece passes through the plurality of elastic pieces and the through holes of the plurality of plates, and is fixedly mounted on the mounting holes of the plurality of block pieces.

5. The sliding rail having the POM grooves according to claim 3, wherein the plurality of plates comprises two plates provided on the slider, and correspondingly, two elastic pieces are provided.

6. The sliding rail having the POM grooves according to claim 1, wherein the connecting piece is a cylindrical shaft.

7. The sliding rail having the POM grooves according to claim 1, wherein the each of the plurality of elastic pieces is a spring.
